(19) United States
(12) Patent Application Publication
(10) Pub. No.: US 2023/0166221 A1
(43) Pub. Date: Jun. 1, 2023

(54) EFFERVESCENT BEVERAGE IN VALVELESS CONTAINER AERATED WITH SPARINGLY SOLUBLE GASES, AND APPARATUSES AND METHODS FOR MAKING THE SAME

(71) Applicant: Todd CARMICHAEL, Gladwyne, PA (US)

(72) Inventor: Todd CARMICHAEL, Gladwyne, PA (US)

(21) Appl. No.: 18/070,716

(22) Filed: Nov. 29, 2022

Related U.S. Application Data
(60) Provisional application No. 63/283,979, filed on Nov. 29, 2021.

(51) Int. Cl. B01F 23/2361; A23L 2/54; B65D 41/04; B01F 23/237

(52) U.S. Cl. CPC B01F 23/2361; A23L 2/54; B65D 41/04; B01F 23/237621; B01F 2101/14

(57) ABSTRACT

A system is provided having a seal cap assembly that allows for the dissolution of sparingly soluble gases into a base liquid contained with a valveless container having only a single opening closed by a twist cap. The seal cap assembly is placed over the opening to create a sealed chamber around the opening. Sparingly soluble gas is then added to chilled based liquid between the twist cap and the partially closed opening. After agitating the base liquid and gas, the twist cap is fully closed about the opening of the container to seal the opening. The final beverage product includes the valveless container fully sealed by the twist cap and containing a beverage aerated with at least one sparingly soluble gas.

### CROSS-REFERENCE TO RELATED APPLICATIONS

The instant application claims priority to U.S. Provisional Patent Application No. 63/283,979, filed on Nov. 29, 2021, which is incorporated herein in its entirety.

### BACKGROUND OF THE INVENTION

### Field of the Invention

The present invention relates to pressurized, effervescent, liquid beverages in valveless containers, aerated with gases other than just carbon dioxide. The invention also relates to an apparatus and methods for making such beverages.

### Description of Related Art

Throughout history, humans have enjoyed drinking effervescent beverages, such as beer, sparkling wines, soda pop, or seltzer water for the tingly sensation and refreshing mouthfeel produced by the small bubbles released when such beverages are served. Whether created through fermentation, chemical, or mechanical means, these effervescent beverages are almost universally gassed exclusively with carbon dioxide (CO₂). In the case of beer and sparkling wines, carbon dioxide is a natural by-product of the fermentation process. In contrast, soda pop, seltzer water, and other carbonated beverages are traditionally gassed through the mechanical injection and dissolution of pressurized carbon dioxide into the liquid. Carbon dioxide is the chosen gas for injection because it is plentiful, inexpensive, safe for human consumption, and can maintain relatively stable effervescence for enough time to be consumed after being served without immediately going flat.

The use of carbon dioxide to provide effervescence in sparkling beverages, however, has a significant disadvantage because it substantially changes the flavor profile of the resulting effervescent beverage. Specifically, when carbon dioxide is dissolved in water, it produces carbonic acid in solution: H₂O+CO₂⇄H₂CO₃. Carbonic acid lowers the pH of the beverage to between 3 and 4. This results in the acidic “bite” and slightly tart flavor associated with plain seltzer water. Although some find the acidic bite of seltzer water refreshing, others do not. Moreover, if the desired end product is a sweet effervescent beverage, such as soda pop, additional sugar or artificial sweeteners must be added to the liquid to counteract the acidity and mask the tartness of the carbonic acid. Frequently, the consumers of such effervescent beverages do not want the added calories associated with additional sugar or they may have reservations about consuming beverages with artificial sweeteners.

Accordingly, there is a long-felt, but unmet demand within the sparkling refreshment industry for a low-calorie, effervescent beverage that can be sweetened without using large amounts of sugar or typical artificial sweeteners, such as saccharin, acesulfame, aspartame, neotame, or sucralose. The present invention fulfills this need by using different gases such as nitrogen (N₂), nitrous oxide (N₂O), nitrogen dioxide (NO₂), argon (Ar), oxygen (O₂) and/or other gases (potentially mixed with carbon dioxide) to enhance effervescence, mask the “bite” associated with carbonization, and sweeten or otherwise modify the flavor profile of the beverage. It should be noted that the invention and its embodiments described herein is not limited to the sparingly soluble gases specifically named above. Rather, any sparingly soluble gas or combination of such gases that are safe for human consumption may be used in this invention.

It is known in the industry that certain gases such as nitrogen, nitrous oxide, nitrogen dioxide, oxygen, and argon can be partially dissolved in a liquid beverage to briefly provide effervescence (collectively referred to as, “sparingly soluble gases”) without producing the acidity and tartness of the carbonic acid formed from traditional beverage carbonation. Moreover, these inert gases impart a naturally sweet flavor to the effervescent beverage without the added calories of sugar or the use of artificial sweeteners.

Recent research has also demonstrated that certain sparingly soluble gases in sufficient concentrations (such as nitrous oxide) not only sweeten the flavor profile of beverages, but also counteract or “mask” the tart bite associated with carbonated beverages on a neurological level—separate and distinct from the gustatory and olfactory systems, shared by all other food and beverages. Accordingly, by aerating a liquid with the proper combination of carbon dioxide and a sparingly soluble gas (like nitrous oxide) at a specific temperature and pressure, one can produce a low-calorie, sweet beverage that maintains relatively stable effervescence without the tart bite of traditional carbonation.

Unfortunately, unlike carbon dioxide, sparingly soluble gases such as nitrogen, nitrous oxide, nitrogen dioxide, and argon are extremely difficult to use as a source of effervescence precisely because they will not stay dissolved in aqueous solutions unless injected into solution under immense pressure in a sealed container through a one-way aeration valve. The term, “valve” as used herein, refers to a sealable opening in the container (other than a twist-cap opening), used to add gas to the beverage's container. Even then, it is extremely difficult to contain such a beverage while it is being aerated with a sparingly soluble gas because the container holding the beverage must be vigorously agitated to allow the sparingly soluble gas to dissolve into the solution. This results in a highly unstable solution immediately following aeration and agitation, and any attempt to depressurize the container to remove the aeration valve will result in the beverage and the sparingly soluble gas quickly (and potentially explosively) escaping from the container. Accordingly, prior efforts in the industry to create beverages aerated with sparingly soluble gases have often required that the container, holding the beverage to be consumed by the end-user, and have separate an aeration valve (apart from the mouth opening of the container) as an artifact of manufacture. See, e.g., U.S. Pat. No. 10,051,874 (“Carmichael, et al.; hereby incorporated by reference in its entirety).

Other efforts to develop effervescent beverages aerated with sparingly soluble gases have required the inclusion of a two-way valve, where the seal is maintained by a dispenser (such as an aerosol valve) and an actuator means to briefly open the beverage to dispense the effervescent beverage directly into the mouth of the consumer-akin to spraying whipped cream into one's mouth directly from a pressurized canister. See U.S. Pat. App. Pub. Nos. 2002/0162458 A1 & 2006/0201331 (collectively, “Farr, et al.”; hereby incorporated by reference in their entirety). While this type of beverage with a specialized two-way, valved container may have some benefits, such as allowing the fast consumption of the beverage on-the-go by using a single hand, the requirement of directly dispensing the highly pressurized beverage directly into the consumer's mouth does not allow a consumer to enjoy the beverage in a traditional method, such as by pouring it into a glass or savoring the beverage as it is slowly sipped from a mouth of an uncapped bottle.

Furthermore, the required inclusion of such one-way or two-way valves in the container used by the consumer of these products presents a significant drawback to the manufacture, transport, and storage of effervescent beverages aerated with sparingly soluble gases. Specifically, the valve creates an intrinsic weak point in the overall integrity of the container. This is especially true since most containers holding effervescent beverages aerated with sparingly soluble gases must maintain a much higher internal pressure than typical carbonated beverages to the keep the sparingly soluble gases dissolved in the beverage. Thus, such valved containers are more susceptible to rupture, leakage, and contamination during manufacture, transport, and storage. Furthermore, the inclusion of such a valve on each container used by the consumer adds unwanted complexity, weight, and expense to the manufacture, transport, and storage of the effervescent beverage.

Thus, an unmet desire and need exists for the development of an effervescent beverage product—aerated at least in part with one or more sparingly soluble gases—that can be simply and inexpensively manufactured in, transported in, and/or stored in a valveless container. The present inventions fulfill this desire and need.

### SUMMARY OF THE INVENTIONS

Embodiments of the inventions include manufactures being effervescent beverage products manufactured in, transported in, and/or stored in a valveless, twist-capped containers that use at least one or more sparingly soluble gases to provide effervescence and modify the flavor profile of a base liquid for human consumption (“sparingly soluble gassed beverages”); processes and methods for making such valveless, sparingly soluble gassed beverages; and machines and systems for making such valveless, sparingly soluble gassed beverages.

An embodiment of the manufactures is a pressurized, effervescent liquid beverage product including a base liquid contained within in a valveless pressurized container, wherein an opening of the container is sealable with a twist cap; wherein the base liquid is effervesced with at least one sparingly soluble gas dissolved in the base liquid.

The container of the liquid beverage product may have a headspace pressurized to less than approximately 690 kPa.

Alternatively, the container of the liquid beverage product may have a headspace pressurized to between approximately 344 to 552 kPa.

Conversely, the container of the liquid beverage product may have a headspace pressurized to between approximately 552 to 690 kPa.

The twist cap of the liquid beverage product may be a threaded screw cap.

The base liquid of the liquid beverage product may be effervesced with a mixture of carbon dioxide and at least one sparingly soluble gas.

Further, the base liquid of the liquid beverage product may be effervesced with a mixture of carbon dioxide and at least one sparingly soluble gas and have a pH of approximately 4.0 or greater.

An embodiment of the processes includes a method for making a sparingly soluble gassed beverage, the steps including a) capping a valveless container, having a single opening sealable with a twist cap and containing a chilled base liquid, by placing the twist cap over the opening of the container and partially tightening the twist cap sufficiently to prevent leakage of the base liquid from the container, but allowing pressurized gases to flow under the twist cap and into the container through the opening; b) gassing the base liquid by adding at least one pressurized, sparingly soluble gas to the container through the opening and under the partially-tightened twist cap, c) agitating the base liquid in the container to dissolve the at least one sparingly soluble gas into the base liquid; and d) immediately sealing the container once gassing is complete by fully tightening the twist cap around the opening so that the at least one sparingly soluble gas cannot leak out of the container.

The method may further require that sufficient gas is added to the container to produce a headspace pressurized to between approximately 137 to 690 kPa once the container is sealed.

The method may alternatively require that sufficient gas is added to the container to produce a headspace pressurize to between approximately 137 to 552 kPa once the container is sealed.

The method may instead require that sufficient gas is added to the container to produce a headspace pressurize to between approximately 552 to 690 kPa once the container is sealed.

The method, prior to step a), may further include adding the chilled base liquid to the container.

The method may instead further include, prior to step a), filling the container with base liquid and chilling the base liquid held within the container.

The method may require that the chilled base liquid has a temperature range of approximately just above the base liquid's freezing point to 4.50° C. (40° F.).

An embodiment of the machines includes a seal cap assembly configured to engage with at least a twist cap for covering an opening of a container having a single opening to produce an air-tight seal around the opening, the seal cap assembly including an external housing positionable over the opening of the container such that the opening is securable within the external housing; a rim along an outer surface of the external housing configured to engage a surface of the container along an area surrounding the opening of the container to form an air-tight seal between the external housing and the container; a gas inlet secured to the external housing and configured to optionally supply pressurized gas into an internal air-tight space formed between the external housing and the container; and a cap wrench attached to and rotatable about a shaft and secured within the external housing, the cap wrench configured to releasably engage with the twist cap and rotate to fully tighten and seal the twist cap about the opening of the container.

Another embodiment of the machines involves a machine for making a sparingly soluble gassed beverage, which includes a seal cap assembly having an external housing positionable over an opening of a container having a single opening such that the opening is securable within the external housing, a rim along an outer surface of the external housing configured to engage a surface of the container along an area surrounding the opening of the container to form an air-tight seal between the external housing and the container, a gas inlet secured to the external housing and configured to optionally supply pressurized gas into an internal air-tight space formed between the external housing and the container, and a cap wrench attached to and rotatable about a shaft and secured within the external housing, the cap wrench configured to releasably engage with the twist cap and rotate to fully tighten and seal the twist cap about the opening of the container; a gas supply fluidly connected to the gas inlet of the seal cap assembly and containing the pressurized gas; and an agitator configured to mechanically stir or disturb a base liquid held within the container.

The machine may further include a machine housing, wherein the seal cap assembly, gas supply, and agitator are secured to or contained within the machine housing.

Another embodiment of the machines includes a system for making a sparingly soluble gassed beverage, the system having one or more containers, each container of said one or more containers having a single opening and a twist cap configured to be secured over the opening; a seal cap assembly having an external housing positionable over the opening of a container of said one or more containers such that the opening is securable within the external housing, a rim along an outer surface of the external housing configured to engage a surface of the container of said one or more containers along an area surrounding the opening of the container of said one or more containers to form an air-tight seal between the external housing and the container of said one or more containers, a gas inlet secured to the external housing and configured to optionally supply pressurized gas into an internal air-tight space formed between the external housing and the container of said one or more containers, and a cap wrench attached to and rotatable about a shaft and secured within the external housing, the cap wrench configured to releasably engage with the twist cap and rotate to fully tighten and seal the twist cap about the opening of the container of said one or more containers; a gas supply fluidly connected to the gas inlet of the seal cap assembly and containing the pressurized gas; and an agitator configured to mechanically stir or disturb a base liquid held within the container.

In the system, each container of the one or more containers may hold a base liquid for effervescence by at least one sparingly soluble gas.

The base liquid in the system may be chilled to a temperature range of approximately just above the base liquid's freezing point to 4.50° C. (40° F.).

### BRIEF DESCRIPTION OF THE SEVERAL VIEWS OF THE DRAWINGS

The invention is best understood by reference to the following descriptions taken in conjunction with the accompanying drawing figures in which:

FIG. 1 is a cross-sectional view of a pressurized, effervescent liquid beverage product according to the invention with a base liquid effervesced with at least one sparingly soluble gas in a valveless twist cap container.

FIG. 2 is a side plan view of a system for effervescing a base liquid with at least one sparingly soluble gas in a valveless twist cap container, the system including the twist cap container, a seal cap assembly, and an agitator.

FIG. 3 is a cross-sectional view along the seal cap assembly engaged with a pressurized, effervescent liquid beverage product, following gassing and agitation of the base liquid, and the tightening/sealing of the twist cap to the container.

FIG. 4 is a flow chart of a method for producing a pressurized, effervescent beverage product manufactured in, transported in, and/or stored in a valveless, twist-capped container that uses at least one or more sparingly soluble gases to provide effervescence and modify the flavor profile of a base liquid for human consumption.

FIG. 5A shows a cross-sectional view of the seal cap assembly about to engage with the container, where an opening of the container is covered with an untightened/unsealed twist cap.

FIG. 5B is a cross-sectional view of the seal cap assembly engaged with the container and the partially-tightened twist cap, where pressurized, sparingly soluble gas is being added to the base liquid under the partially-tightened twist cap, while the base liquid is being agitated.

FIG. 5C is a cross-sectional view of the seal cap assembly engaged with the container and the twist cap is tightened/sealed to the opening by rotating a shaft attached to a cap wrench of the seal cap assembly.

FIG. 5D is a cross-sectional view of the seal cap assembly disengaging from a fully sealed container of the pressurized, effervescent liquid beverage product after the twist cap has been fully tightened.

FIG. 6A is a perspective view of an alternative embodiment of the system for effervescing a base liquid with at least one sparingly soluble gas in a valveless twist cap container, the alternative embodiment of the system including a plurality of seal cap assemblies to simultaneously effervesce multiple containers having a base liquid with at least one sparingly soluble gas.

FIG. 6B is a front plan view of the system of FIG. 6A.

FIG. 6C is a top plan view of the system of FIG. 6A.

FIG. 7A is a front view of an embodiment of a machine for making a sparingly soluble gassed beverage.

FIG. 7B is a top perspective view of the machine of FIG. 7A.

FIG. 7C is a side view of the machine of FIG. 7A.

### DETAILED DESCRIPTION

The following detailed description of embodiments of the present invention will be better understood when read in conjunction with the appended drawings. For the purpose of illustrating the inventions, there are shown in the drawings embodiments which are presently preferred. It is understood, however, that the invention is not limited to the precise arrangements and instrumentalities shown.

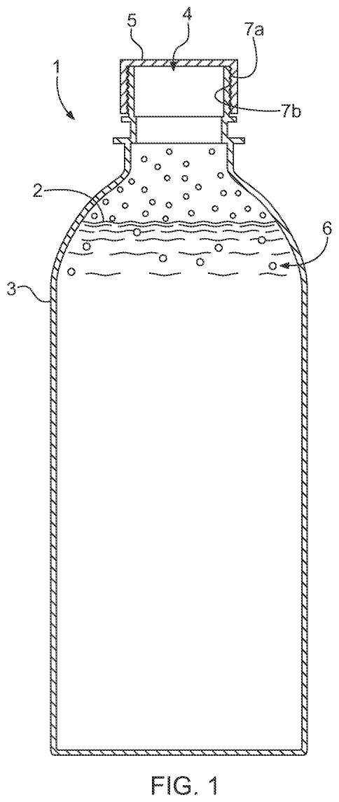

FIG. 1 depicts a pressurized, effervescent liquid beverage product 1 according to an embodiment of the invention. The liquid beverage product 1 includes a valveless, pressurized container 3 having a single opening 4 sealed with a twist cap 5. Inside the sealed container 3 is a base liquid 2 effervesced with at least one sparingly soluble gas 6, represented in the drawings as small circles or dots within the container 3, which is dissolved in the base liquid 2. The liquid beverage product 1 of FIG. 1 is a final product of various methods of producing the same, described herein, and is produced via various machines and systems, also described herein.

The shape of the container 3 may differ from the illustration shown in FIG. 1, which is a generalized illustration. As already discussed, it has been known in the art to attempt aeration of a liquid with a sparingly soluble gas in a container having either an aeration valve separate from an opening for pouring or drinking the final beverage, or having a two-way valve. Therefore, regarding the specific shape and structure of the container 3 for the purposes of the present invention, it is sufficient that the container is valveless. A simple and ubiquitous container that is valveless is a twist cap container, as commonly encountered with single-use bottles for soft drinks or bottled water. The container is preferably designed to allow for a headspace pressure of equal to or less than approximately 690 kPa (100 PSI). Further, the container is preferably designed to allow for a headspace pressure of between approximately 137 to 690 kPa (20 to 100 PSI). More preferably, the container is designed to allow for a headspace pressure of between approximately 137 to 552 kPa (20 to 80 PSI). More preferably still, the container is designed to allow for a headspace pressure of between approximately 344 to 552 kPa (50 to 80 PSI). For the purposes of converting between different units of measurement and rounding up or down, the use of “approximately” herein accounts for +/−one unit of measurement in either the standard or imperial unit when discussing numerical values, such as pressure or temperature values.

The preferred embodiment of the container 3 includes the twist cap 5 for securing to and sealing the opening 4 of the container. The twist cap 5 can take the form of a traditional fully or partially threaded screw cap used in most single-use water or beverage bottles, which includes threads 7a on the twist cap corresponding to threads 7b positioned around the opening 4 of the container 3. Other types of various twisting closure mechanisms that allow for incremental tightening of a seal between the cap and the opening to the container are considered for use as the twist cap 5, such as a twist-off metal “crown cap” (frequently used on beer bottles); a Luer Lock-type twist cap; a twist nozzle cap (frequently used on condiment dispensing containers); or a friction-based tapered or incrementally ridged bottle stopper (such as a natural or artificial cork), which employs, in-part, a twisting motion to unseal or reseal the opening to a wine bottle).

The base liquid 2 is preferably tap water, but may also include non-tap water, fruit and/or vegetable juice(s), tea, coffee, milk, or other aqueous solutions (such as vitamin and/or mineral-enhanced mixtures), alcohol, caffeine, or combinations thereof. Flavoring, essences, compounds, etc. may additionally be added to the base liquid to affect taste or mouth feel. The beverage product 1 includes at least one sparingly soluble gas, such as nitrogen (N₂), nitrous oxide (N₂O), nitrogen dioxide (NO₂), argon (Ar), oxygen (O₂), helium (He), and combinations thereof, or other gases suitable for human consumption. In addition, combinations of one or more sparingly soluble gases and carbon dioxide (CO₂) can be used to provide effervescence and modify the beverage's flavor profile by masking the acidic bite of the carbon dioxide in any gas mixtures used.

The pH of the base liquid 2 effervesced with at least one sparingly soluble gas in the beverage product 1 may vary based on specific formulas and compositions, as long as the final beverage product is safe for human consumption. In an embodiment of the beverage product 1, the beverage product has a pH of 4.0 or greater.

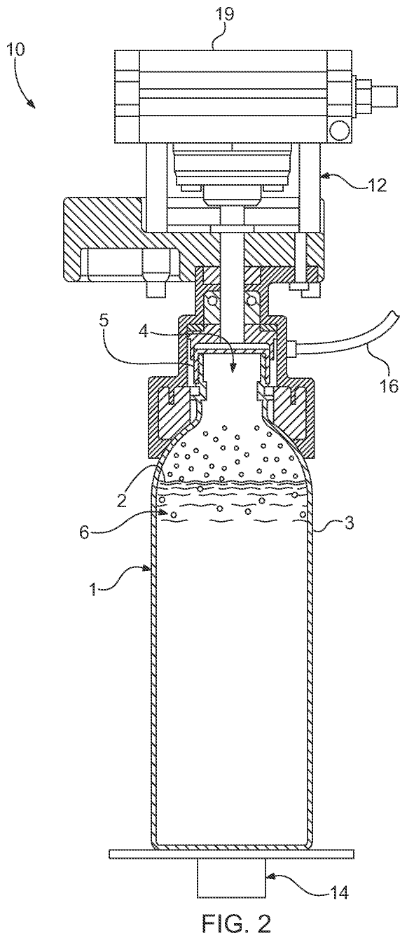

FIG. 2 shows a system 10 for effervescing a base liquid with at least one sparingly soluble gas in a valveless container 3. The system 10 includes the container 3 and twist cap 5 sealed over the opening 4, as part of the final beverage product 1, a seal cap assembly 12, an agitator 14, and a gas supply 16. FIG. 2 shows the final beverage product 1, with the base liquid effervesced with the at least one sparingly soluble gas 6, secured to the seal cap assembly 12 after the container 3 has been sealed with the twist cap 5.

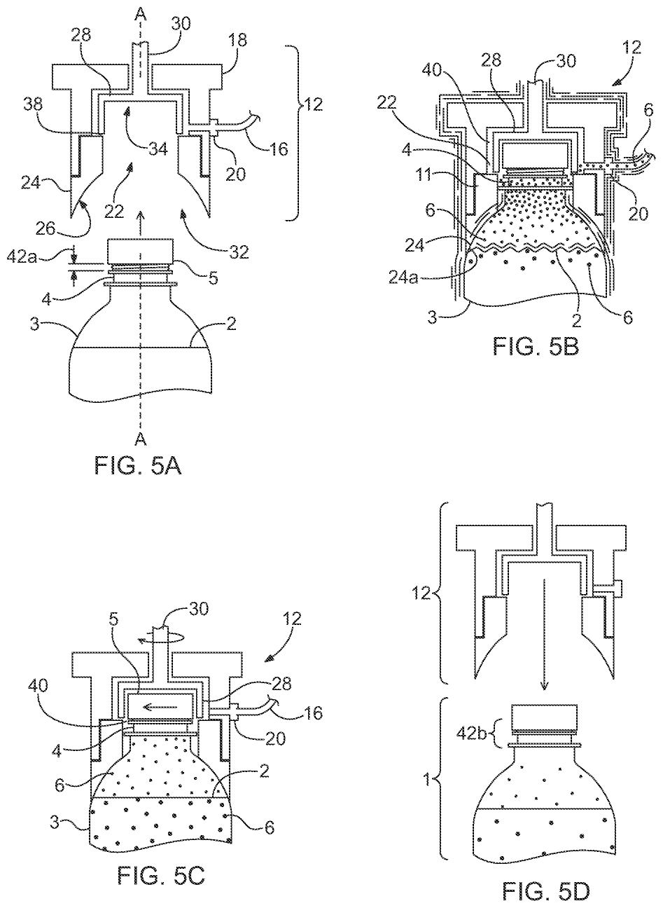

The seal cap assembly 12 is provided in better detail in FIG. 3. The seal cap assembly 12 includes an external housing 18, a gas inlet 20, an internal space 22, a rim 24 along a free end 26, a cap wrench 28, and a shaft 30. The external housing 18 also has an opening 32, shown in FIG. 5A, along the free end 26. The opening 32 is contiguous with the internal space 22, which is generally shaped to at least accept and/or conform to the opening 4 and twist cap 5 of the container 3. The rim 24 extends along the free end 26 and around the opening 32. Preferably, the rim 24 is semi-rigid or deformable to tightly secure around the opening 4 or other surface of the container 3 to provide an air-tight seal between the container and seal cap assembly 12 while the opening is secured within the internal space 22. The rim 24 may be made from, but not limited to, a rubberized material, silicone, plastic or combination thereof.

The cap wrench 28 and shaft 30 are both positioned within the external housing 18. The cap wrench 28 is connected to a longitudinal end 36 of the shaft 30. Preferably, the cap wrench 28 is coaxial with the shaft 30 such that axial rotation of the shaft 30 imparts the same axial rotation of the cap wrench about longitudinal axis A. The cap wrench 28 further includes a free end 38 longitudinally extending opposite to the shaft and toward the free end 26 of the external housing 18, and an opening 34 along the free end 38. The opening 34 is configured to accept the twist cap 5, such that the twist cap is partially or fully securable within the cap wrench 28. The shaft 30 may also be longitudinally translatable along the longitudinal axis A toward and/or away from the free end 26. Longitudinal end 37 of the shaft 30 may be attached to an actuator 19, which may impart the axial rotation onto and longitudinal translation of the shaft and the cap wrench 28.

The external housing 18 is configured to be positioned over the opening 4 of the container 3 to establish an air-tight seal 24a along the free end 26 between the rim 4 and a surface 3a of the container 3. The surface 3a of the container 3 is preferably an area immediately surrounding the opening 4 of the container, such as the “neck” and/or “shoulders” of a bottle, but may be any surface of the container that conforms to the shape of the rim to create the air-tight seal. Once the air-tight seal 24a is formed, an air-tight space 40 is formed in the internal space 22 around at least twist cap 5 and opening 4 of the container 3. The gas inlet 20 is attached to the external housing 18 and is fluidly connected to the internal space 22 and air-tight space 40, once formed. The fluid connection of the gas inlet 20 to the air-tight space 40 is openable and closable to control gas supply to the air-tight space. The gas supply 16 is connectable to the gas inlet 20 to supply gas to the air-tight space 40.

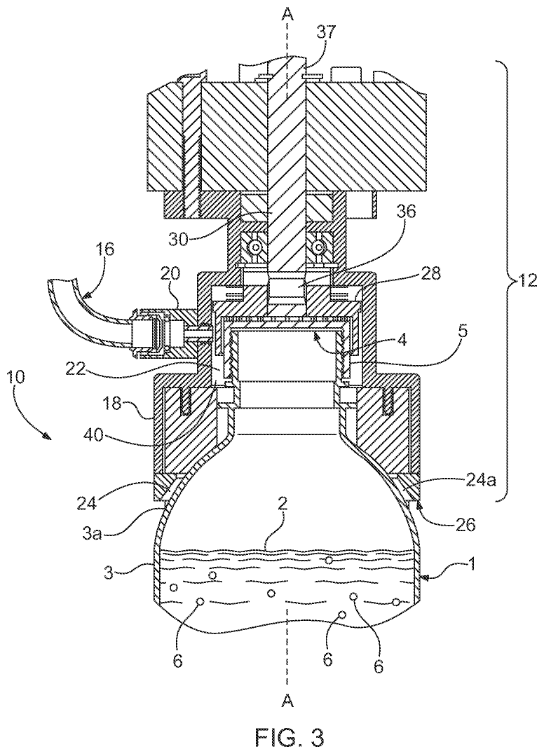

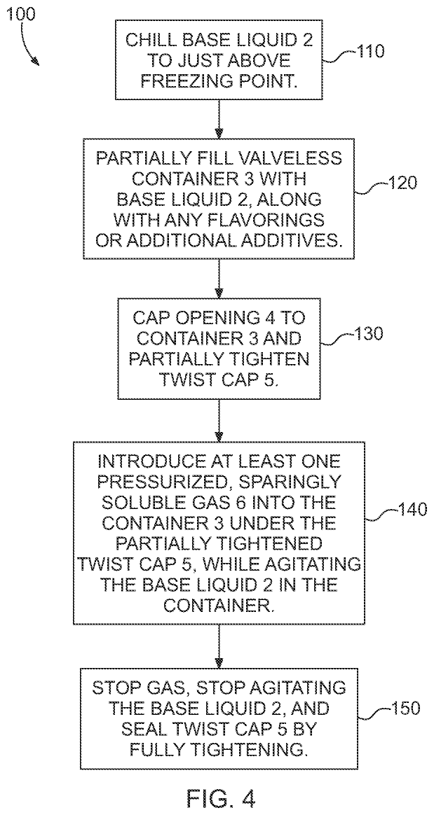

FIG. 4 illustrates a flow chart for a preferred embodiment of a method 100 for producing the pressurized, effervescent beverage product 1 that contains at least one or more sparingly soluble gases 6 to provide effervescence and modify the flavor profile of the base liquid 2 for human consumption. The resulting beverage product 1 is manufactured in, transported in, and/or stored in the valveless container 3.

In a first step 110, the base liquid 2, such as pure, flat water, is chilled to just above its freezing point, approximately 0.50-4.50° C. (33-40° F.).

In a second step 120, the valveless container 3, designed to withstand at least approximately 550 kPa (80 PSI), at the corresponding temperature of the chilled based liquid, of internal headspace pressure and to accept a twist cap 5, is partially filled with the chilled base liquid 2.

A third step 130 involves placing a twist cap 5 on the opening 4 to the container 3 and partially tightening the twist cap so that it will not allow the base liquid 2 to the leave the container 3. However, pressurized gas (including at least one sparingly soluble gas 6) is still allowed to enter the container 3 via the opening 4 under the partially-tightened twist cap 5.

A fourth step 140 provides for introducing the at least one pressurized, sparingly soluble gas 6 into the container 3 under the partially-tightened twist cap 5, while agitating the base liquid 2 in the container 3 so that the gas 6 dissolves into the base liquid 2. In a preferred embodiment, this step is carried out in FIGS. 5A and 5B by placing the container 3 and partially tightened, twist cap 5 into the seal cap assembly 12 of the system 10, which may be used to simultaneously gas and agitate the base liquid 2.

In a final step 150, the gassing and agitation of the base liquid is stopped and the container 3 is sealed by fully tightening the twist cap 5. In a preferred embodiment, depicted in FIGS. 5C and 5D, the twist cap is tightened by the cap wrench 28 attached to the rotating shaft 30. The finished beverage product 1 is then removed from the seal cap assembly 12. The finished beverage product 1 includes the valveless container 3 holding the base liquid 2 aerated with at least one sparingly soluble gas 6 and sealed under pressure.

It should be noted that the first step 110 of chilling the base liquid may occur at any point prior to the step 140 of adding the pressurized gases and agitating the liquid. Further, the agitation in step 140 may occur at a step following the addition of the one or more pressurized gases, including the at least one sparingly soluble gas 6, rather than simultaneously. The resulting beverage product 1 should have an internal pressure of approximately 690 kPa (100 PSI) or less at the corresponding temperature of the chilled based liquid inside the sealed container 3. More preferably, the beverage product 1 should have a pressure range of approximately 275 to 552 kPa (40 to 80 PSI) inside the sealed container 3 to keep the one or more sparingly soluble gases dissolved in the base liquid.

FIGS. 5A-5D show the preferred method of producing the beverage product 1 using a simplified illustration of the seal cap assembly 12 provided in FIGS. 2 and 3. In FIG. 5A, the valveless container 3 holding the non-gassed base liquid 2 is positioned under the seal cap assembly 12. The base liquid 2 is preferably already chilled to the desired temperature range just above its freezing point before it is added to the container 3. However, a refrigeration unit or other method of chilling may be used to chill the base liquid 2 after it is placed in the container 3. The twist cap 5 is positioned over the opening 4 of the container 3 in a partially secured position 42a around the opening such that the base liquid 2 cannot escape, but gases can otherwise freely enter the container. The twist cap 5 is preferably positioned coaxially with the cap wrench 28 and shaft 30 inside the external housing 18.

In FIG. 5B, the external housing 18 is placed over the opening 4 and twist cap 5 and into contact with the container 3. This may be achieved by lowering the seal cap assembly 12, raising the container 3, or a combination thereof. In this embodiment, an arrow above the twist cap 5 in FIG. 5A represents the container 3 and twist cap being moved into the internal space 22 of the seal cap assembly 12. The rim 24 along the free end 26 is placed in contact with the surface 3a of the container 3 to form the air-tight seal 24a. The air-tight seal 24a creates the air-tight space 40 around the twist cap 5 and opening 4 in the internal space 22 of the external housing 18. The twist cap 5 is further secured within the opening 34 of the cap wrench 28.

The gas inlet 20 is then opened to allow a gas or gas mixture containing the at least one or more sparingly soluble gas 6 into the air-tight space 40 from the gas supply 16. The at least one sparingly soluble gas 6 travels into the container 3 between the partially sealed twist cap 5 and opening 4. Various amounts of gas 6 may be introduced into the air-tight space 40 during gassing to achieve a desired headspace pressure, with headspace being the volume of gas within the container 3 positioned between the base liquid 2 and opening 4 when sealed. During or after the introduction of the sparingly soluble gas 6, the agitator 14 is activated to agitate the chilled base liquid 2 to promote dissolution of the gas 6 into the liquid 2. Additional lines in FIG. 5B are shown to represent vibrations and agitation caused by the agitator 14. The container 3 may be agitated for a various length of time and in various manners, as desired to achieve dissolution of the at least one sparingly soluble gas 6.

FIG. 5C shows the cap wrench 28, via axial rotation of the shaft 30, represented by the circular arrow, axially rotating the twist cap 5 to fully close and seal the twist cap to the container 3 and around the opening 4. The twist cap is subsequently in a fully sealed position 42b. The gas inlet 20 is closed, before or after the twist cap reaches the fully sealed position 42b, such that no more gas is released into the air-tight space 40. If not already, the agitator 14 is deactivated.

Lastly, in FIG. 5D, the seal cap assembly 12 and container 3 are separated, as represented by the downward arrow, and the final liquid beverage product 1 is ready for transport, storage, or consumption.

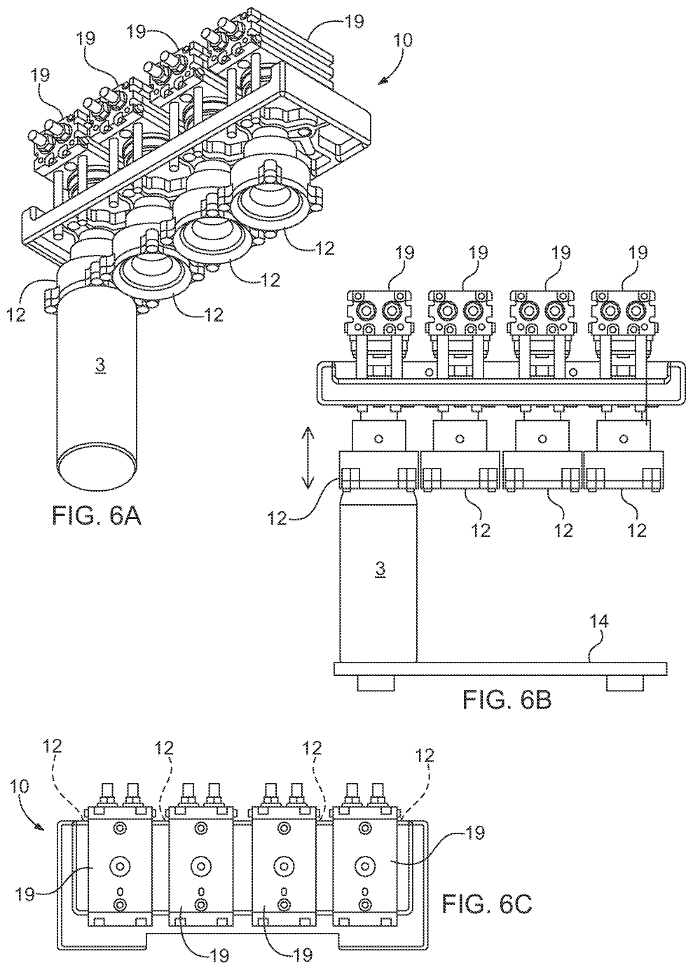

An alternative embodiment of the seal cap system 10 is shown in FIGS. 6A-6C. In this embodiment, the system 10 has a plurality of seal cap assemblies 12. Specifically, four seal cap assemblies 12, each being a seal cap assembly according to the present invention and described herein, are provided to allow for increased production of liquid beverage product 1 according to the present invention. Any other number of seal cap assemblies 12 may be provided in additional embodiments of the seal cap system 10. Each seal cap assembly 12 has its own dedicated actuator 19 for at least operating and moving the shaft 30 of each seal cap assembly 12. Each actuator 19 may further control and/or enable longitudinal translation of the corresponding seal cap assembly 12 up and down to engage with a respective container 3. Each seal cap assembly 12 may have its own dedicated agitator 14 or an agitator may be provided to agitate multiple containers at once.

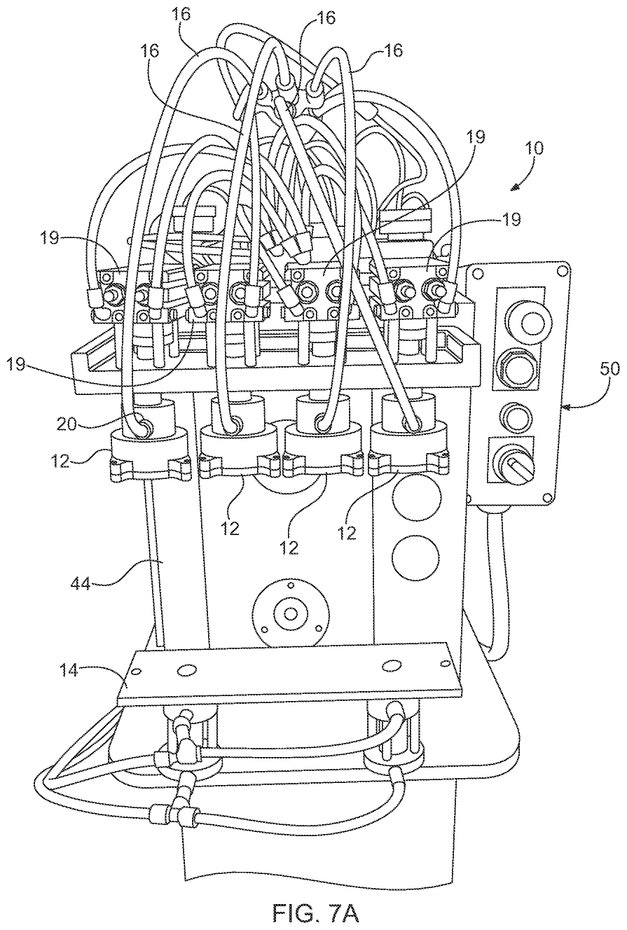

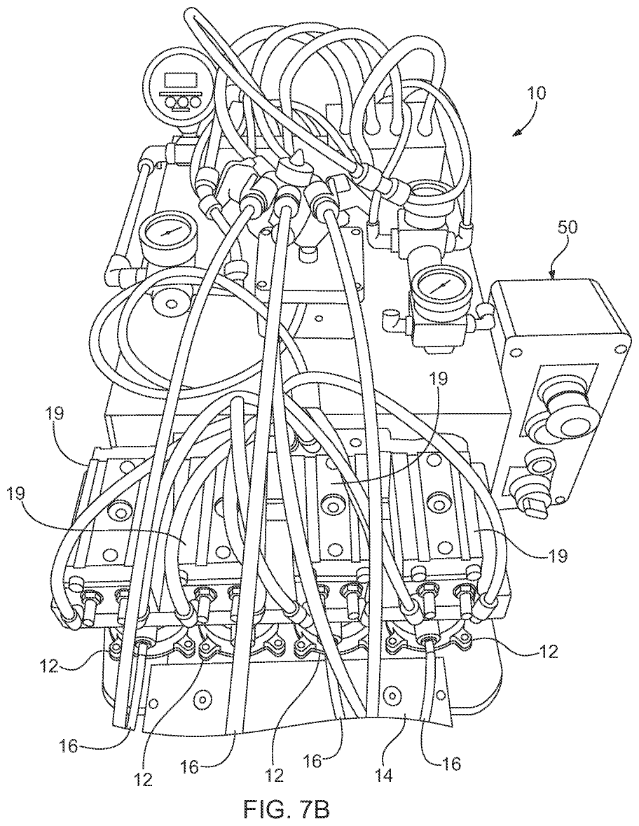

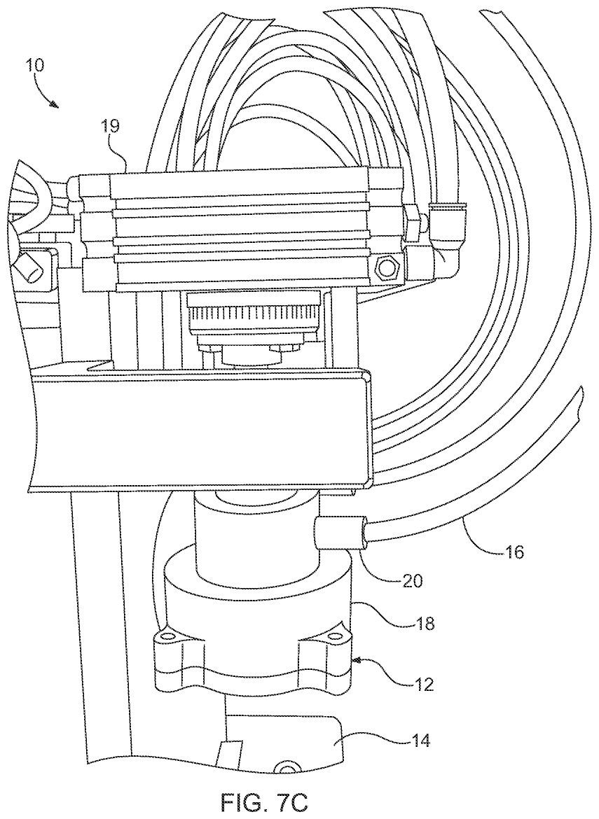

FIGS. 7A-7C provide views of another embodiment of the seal cap system for producing the beverage product 1 according to the various methods described herein. This system 10 is contained within a single machine that includes a housing 44, a plurality of seal cap assemblies 12 as already described, an agitator 14, and at least one gas supply 16 to each seal cap assembly; the machine otherwise referred to as a gasser, shaker, capper apparatus (GSCA). The machine includes four seal cap assemblies 12 oriented over an agitator 14. Both the seal cap assemblies 12 and the agitator 14 are secured to and/or oriented along an outside of the housing 44. The gas supply 16 at least partially contained within the housing 44 and is attached to each seal cap assembly 12 via the corresponding gas inlet 20. Controls 50 are provided to start and stop the machine, and to control various parameters. Such parameters may include duration of various steps, including the gassing and agitation steps, the amount of gas supplied, the force and speed of agitation, and the translation of the seal cap assemblies 12 up and down. Various sensors are also provided to indicate gas supply levels, pressures relating to headspace pressure, and/or base liquid temperature.

### Example

In the following example, the GSCA pictured in FIGS. 7A-7C was used to manufacture a pressurized liquid beverage product 1, effervesced with a mixture of carbon dioxide (CO₂) and sparingly soluble gases comprising approximately 5% nitrogen (N₂), 12% carbon dioxide (CO₂), 40% argon (Ar), and 43% nitrous oxide (N₂O).

Purified tap water was used as the base liquid 2 and chilled to approximately 2.77° C. (37° F.). Approximately 414 mL (14 oz.) of the chilled water and a trace amount of watermelon flavoring essence was transferred to a pressure-resistant single-use plastic bottle being the container 3 (with a total empty volume of 450 mL and capable of withstanding up to approximately 550 kPa (80 PSI) internal pressure with a threaded twist cap 5.

The twist cap 5 was placed over the opening 4 of the container 3 and partially tightened to the point where pressurized gas could enter the container 3 under the screw cap, but base liquid 2 would not leak out when agitated. The container 3 was then placed in the GSCA, so that the capped opening and the immediately surrounding portion of the container engaged with the seal cap assembly 12 to form an air-tight space 40 between the seal cap assembly and capped opening 4 of the bottle.

The pressurized mixture of carbon dioxide and sparingly soluble gasses 6 was then introduced through the gas inlet 20 into the air-tight space 40 formed between the seal cap assembly 12 and the capped opening 4 of the container 3, so that the mixture of gases could flow under the partially tightened cap and into the container. Simultaneously, the container 3 holding the base liquid 2 and gas mixture 6 was vigorously agitated (consistent with whipped cream manufacturing) by the GSCA's shaker mechanism, or agitator 14, for approximately 25 seconds. Approximately seven to eight gas volumes of the gas mixture were pumped into the bottle.

Immediately after stopping agitation, the flow of the gas mixture was turned off and the partially tightened cap 5 on the opening of the bottle was fully tightened and sealed by turning the cap wrench 28 inside the seal cap assembly with the rotating shaft 30. The container 3, now being a component of the finished beverage product 1, was then disengaged from the seal cap assembly of the GSCA.

The resulting finished product is a pressurized, effervescent, liquid beverage in a valveless bottle that maintains its effervescence whether it is consumed directly from the bottle or poured out into a glass. It is slightly sweet, has no acidic “bite,” uses no artificial sweeteners, and has zero calories. This particular embodiment had a resulting pH of approximately 4.2 and an internal headspace pressure of approximately 427 kPa (62 PSI) at approximately 2.77° C. (37° F.). Because the container 3 lacks any valves, the beverage product 1 can be easily manufactured, transported, stored, and consumed directly from the container with little risk for rupture of the container or leakage of the liquid 2 even though it has an internal headspace pressure that is significantly higher than a typical “carbonated” beverage (which usually ranges from approximately 137 to 345 kPa (20 to 50 PSI).

The specific embodiments described above have been shown by way of example, and these embodiments may be susceptible to various modifications and alternative forms. It should be further understood that the claims are not intended to be limited to particular forms disclosed, but rather to cover all modifications, equivalents, and alternatives falling within the spirit and scope of this disclosure.

What is claimed is:

1. A pressurized, effervescent liquid beverage product, comprising:
a base liquid contained within in a valveless pressurized container, wherein an opening of the container is sealable with a twist cap;
wherein the base liquid is effervesced with at least one sparingly soluble gas dissolved in the base liquid.

2. The beverage product of claim 1, wherein the container has a headspace pressurized to less than approximately 690 kPa.

3. The beverage product of claim 1, wherein the container has a headspace pressurized to between approximately 344 to 552 kPa.

4. The beverage product of claim 1, wherein the container has a headspace pressurized to between approximately 552 to 690 kPa.

5. The beverage product of claim 1, wherein the twist cap is a threaded screw cap.

6. The beverage product of claim 1, wherein the base liquid is effervesced with a mixture of carbon dioxide and the at least one sparingly soluble gas.

7. The beverage product of claim 1, wherein the base liquid is effervesced with a mixture of carbon dioxide and the at least one sparingly soluble gas and has a pH of approximately 4.0 or greater.

8. A method for making a sparingly soluble gassed beverage, comprising the following steps:
a) capping a valveless container, having a single opening sealable with a twist cap and containing a chilled base liquid, by placing the twist cap over the opening of the container and partially tightening the twist cap sufficiently to prevent leakage of the base liquid from the container, but allowing pressurized gases to flow under the twist cap and into the container through the opening;
b) gassing the base liquid by adding at least one pressurized, sparingly soluble gas to the container through the opening and under the partially-tightened twist cap,
c) agitating the base liquid in the container to dissolve the at least one sparingly soluble gas into the base liquid; and
d) immediately sealing the container once gassing is complete by fully tightening the twist cap around the opening so that the at least one sparingly soluble gas cannot leak out of the container.

9. The method of claim 8, wherein sufficient gas is added to the container to produce a headspace pressurized to between approximately 137 to 690 kPa once the container is sealed.

10. The method of claim 8, wherein sufficient gas is added to the container to produce a headspace pressurize to between approximately 137 to 552 kPa once the container is sealed.

11. The method of claim 8, wherein sufficient gas is added to the container to produce a headspace pressurize to between approximately 552 to 690 kPa once the container is sealed.

12. The method of claim 8, further comprising, prior to step a), adding the chilled base liquid to the container.

13. The method of claim 8, further comprising, prior to step a), filling the container with base liquid and chilling the base liquid held within the container.

14. The method of claim 8, wherein the chilled base liquid has a temperature range of approximately just above the base liquid's freezing point to 4.50° C.

15. A seal cap assembly configured to engage with at least a twist cap for covering an opening of a container having a single opening to produce an air-tight seal around the opening, comprising:
an external housing positionable over the opening of the container such that the opening is securable within the external housing;
a rim along an outer surface of the external housing configured to engage a surface of the container along an area surrounding the opening of the container to form an air-tight seal between the external housing and the container;
a gas inlet secured to the external housing and configured to optionally supply pressurized gas into an internal air-tight space formed between the external housing and the container; and
a cap wrench attached to and rotatable about a shaft and secured within the external housing, the cap wrench configured to releasably engage with the twist cap and rotate to fully tighten and seal the twist cap about the opening of the container.

16. A machine for making a sparingly soluble gassed beverage, comprising:
a seal cap assembly having
an external housing positionable over an opening of a container having a single opening such that the opening is securable within the external housing,
a rim along an outer surface of the external housing configured to engage a surface of the container along an area surrounding the opening of the container to form an air-tight seal between the external housing and the container,
a gas inlet secured to the external housing and configured to optionally supply pressurized gas into an internal air-tight space formed between the external housing and the container, and
a cap wrench attached to and rotatable about a shaft and secured within the external housing, the cap wrench configured to releasably engage with the twist cap and rotate to fully tighten and seal the twist cap about the opening of the container;
a gas supply fluidly connected to the gas inlet of the seal cap assembly and containing the pressurized gas; and
an agitator configured to mechanically stir or disturb a base liquid held within the container.

17. The machine of claim 16, further comprising a machine housing, wherein the seal cap assembly, gas supply, and agitator are secured to or contained within the machine housing.

18. A system for making a sparingly soluble gassed beverage, comprising:
one or more containers, each container of said one or more containers having a single opening and a twist cap configured to be secured over the opening;
a seal cap assembly having
an external housing positionable over the opening of a container of said one or more containers such that the opening is securable within the external housing,
a rim along an outer surface of the external housing configured to engage a surface of the container of said one or more containers along an area surrounding the opening of the container of said one or more containers to form an air-tight seal between the external housing and the container of said one or more containers,
a gas inlet secured to the external housing and configured to optionally supply pressurized gas into an internal air-tight space formed between the external housing and the container of said one or more containers, and
a cap wrench attached to and rotatable about a shaft and secured within the external housing, the cap wrench configured to releasably engage with the twist cap and rotate to fully tighten and seal the twist cap about the opening of the container of said one or more containers;
a gas supply fluidly connected to the gas inlet of the seal cap assembly and containing the pressurized gas; and
an agitator configured to mechanically stir or disturb a base liquid held within the container.

19. The system of claim 18, wherein said each container of the one or more containers hold a base liquid for effervescence by at least one sparingly soluble gas.

20. The system of claim 19, wherein the base liquid is chilled to a temperature range of approximately just above the base liquid's freezing point to 4.50° C.
